(19) United States
(12) Patent Application Publication
(10) Pub. No.: US 2006/0287419 A1
(43) Pub. Date: Dec. 21, 2006

(54) Composition for preparation of thermoplastic polyurethane elastomer used in powder slush molding process

(75) Inventors: Sung-Kuk Park, Gyeonggi-do (KR); Yong Chun, Gyeonggi-do (KR); Young-Kil Lee, Seoul (KR); Hee-Chung Lee, Gyeonggi-do (KR); Young-Whi Park, Seoul (KR); Yang-Lae Cho, Gyeongsangnam-do (KR); Dae-Yong Kwon, Ulsan (KR); Jin-Suk Choi, Seoul (KR)

Correspondence Address: GREENBLUM & BERNSTEIN, P.L.C., 1950 ROLAND CLARKE PLACE, RESTON, VA, 20191, US

(73) Assignees: Hyundai Mobis Co., Ltd., Seoul (KR); Hosung Chemex Co., Ltd., Seoul (KR)

(21) Appl. No.: 11/311,329

(22) Filed: Dec. 20, 2005

(30) Foreign Application Priority Data
Jun. 15, 2005 (KR) 10-2005-0051427

(51) Int. Cl. C08L 91/06

(52) U.S. Cl. 524/277

(57) ABSTRACT

The current invention relates to a composition for the preparation of thermoplastic polyurethane elastomer for use in a powder slush molding process. The composition for the preparation of thermoplastic polyurethane elastomer includes a polymer consisting of isocyanate, a chain-extension agent and polyol, and montan wax. When the thermoplastic polyurethane elastomer prepared using the composition of the current invention is used in a powder slush molding process, a molded end product is easily released at a powder slush molding process, and molding energy is lowered by lowing a process temperature, thereby shortening a process cycle time, and also, the decreased incidence of a blooming phenomenon and of pin holes results in improved flatness of the molded product. The molding composition of this invention is suitable for manufacturing skin materials of automobile instrument panels.

### CROSS-REFERENCE TO RELATED APPLICATIONS

The present application is based on, and claims priority from, Korean Application Serial Number 10-2005-0051427, filed on Jun. 15, 2005, the disclosure of which is hereby incorporated by reference herein in its entirety.

### FIELD OF THE INVENTION

The present invention relates to a composition for the preparation of a thermoplastic polyurethane elastomer (TPU) comprising ether-containing polyester polyol, which can be used to produce a molded product through a powder slush molding process to improve processability and flatness of the molded product. In addition, the present invention relates to a method of producing a TPU molded product from the composition using a powder slush molding process.

In addition, the present invention relates to a molded product produced using the above method. More particularly, the present invention relates to a composition for the preparation of TPU for a powder slush molding process, obtained by adding a polymer, resulting from polymerization of ether-containing polyester polyol, with C28-C32 montan wax, serving as an external slip agent.

When the composition is used, a TPU molded product is easily released from a mold in a powder slush molding process, and a process temperature is lowered and less molding energy is required, thereby shortening a process cycle time, and also, flatness of the molded product is improved. In addition, the present invention relates to a method of preparing TPU to be produced into a molded product using the composition through a powder slush molding process. In addition, the present invention relates to a TPU molded product comprising ether-containing polyester polyol, produced using the polymer through a powder slush molding process.

### BACKGROUND OF THE INVENTION

Generally, skin materials for instrument panels of automobiles require properties including product performance, such as design freedom, embossing transcription quality, and tactile sensation; durability, such as scratch resistance, heat aging resistance, light resistance, and chemical resistance; and safety, such as an anti-fogging property, incombustibility, and adaptability to air bag deployment.

As the current of the shapes of automobile interior toward being complicated, the skin material for an automobile instrument panel is mainly manufactured using a powder slush molding process providing high design freedom. In a powder slush molding process, TPU has higher tackiness than other thermoplastic elastomers and is thus difficult to be released from a mold after molding.

If the resin is difficult to be released from the mold, resin residue may remain on the mold upon release, and a folding phenomenon may occur during release and thus marks, which are difficult to be restored, may be formed, resulting in degraded product value.

Moreover, if the product is difficult to be released, a time for a process cycle is lengthened to reduce productivity. Therefore, in order to provide release performance, a release agent can be applied to the mold. However, due to the use of the release agent, an undesired scar is formed on products, causing non-uniform gloss, resulting in degraded product value.

In order to solve such problems, a typical external slip agent is internally added to TPU which is prepared using sintered powder, to decrease tackiness between the metal and the resin, thereby realizing easy release.

However, since the external slip agent has a limited saturation concentration, when it is higher than its saturation concentration, the problem of blooming or migration to the surface may be caused.

Further, the saturation concentration of the slip agent varies with the temperature, and the behavior of the slip agent is difficult to actually predict. In addition, the compatibility of the slip agent with TPU is considered important. In the compatibility of the slip agent with TPU, different slip agents provide the maximum compatibility at different concentrations. In the case of using the slip agent incompatible with TPU, white turbidity phenomenon may occur. Accordingly, before using the slip agent, compatibility with the resin should be checked.

Korean Patent Application No. 2001-0062458 discloses a method for preparing flexible TPU where ether-containing polyester polyol is used as polyol for the synthesis of TPU, and tactile sensation, elasticity, water resistance, specific gravity are improved, and capable of being sintered to be stable to light, and TPU prepared thereby.

In the above patent, TPU comprising ether-containing polyester polyol is prepared by mixing 15-60 parts by weight of isocyanate, 30-70 parts by weight of ether-containing polyester polyol, and 5-40 parts by weight of a chain-extension agent, followed by polyaddition reaction.

### SUMMARY OF THE INVENTION

Embodiments of the present invention provide a TPU composition for use in a powder slush molding process to improve processability and surface properties of a molded product, TPU prepared using the TPU composition, and a molded product produced using TPU through a powder slush molding process.

### DETAILED DESCRIPTION OF THE PREFERRED EMBODIMENTS

The present invention provides a composition for the preparation of TPU for use in a powder slush molding process, the composition comprising a polymer including 30-70 parts by weight of ether-containing polyester polyol, 15-60 parts by weight of isocyanate and 5-40 parts by weight of a chain-extension agent, and 0.1-5 parts by weight of montan wax, serving as a slip agent, relative to 100 parts by weight of the polymer.

Further, the present invention provides a composition for the preparation of TPU, wherein the montan wax may comprise at least one selected from the group consisting of esters of montanic acids with ethylene glycol, esters of montanic acids with glycerine, calcium montanate containing montanic acid esters, and complex esters of montanic acids.

Further, the present invention provides a composition for the preparation of TPU, wherein the montan wax is at least two montan wax which includes calcium montanate containing montanic acid esters.

Further, the present invention provides a composition for the preparation of TPU, wherein the montan wax is calcium montanate containing montanic acid esters.

When the montan wax is used in an amount less than 0.1 parts by weight relative to 100 parts by weight of the polymer, it is difficult to release TPU from the mold upon release during a powder slush molding process.

Further, upon release, TPU residue may undesirably remain on the mold, and folded marks may also be present, thus product value may be degraded. When the montan wax is used in an amount exceeding 5 parts by weight relative to 100 parts by weight of the polymer, the slip agent included in the polymer has a concentration higher than a saturation concentration thereof, thus blooming or migration may occur.

Calcium montanate containing montanic acid esters is a secondary product resulting from oxidation and purification of montan wax, which is esterified with butylene glycol, and the remaining part of which is saponified with calcium hydroxide.

When the composition including montan wax for the preparation of TPU is used in a powder slush molding process, a release film is formed between the mold and the resin to facilitate the resin from the mold. Moreover, heat is easily dissipated, and a process temperature is lowered, thereby less process energy is required. Upon molding, surface roughness of the molded product is decreased due to the repeated adhesion and slipping, so that molded end products can have improved flatness.

Further, in the composition for the preparation of TPU of the present invention, ether-containing polyester polyol comprises a polyfunctional carboxylic acid compound, a polyfunctional alcohol compound, and polytetramethylene ether glycol (PTMG), with a hydroxyl value of 11.22-224.11 mgKOH/g.

The ether-containing polyester polyol is prepared in a manner such that a polyfunctional carboxylic acid compound, a polyfunctional alcohol compound, and polytetramethylene ether glycol are mixed together and are then allowed to react, thus realizing a hydroxyl value of 11.22-224.11 mgKOH/g. The content of the polyfunctional carboxylic acid compound and polytetramethylene ether glycol may be 40-80 parts by weight and 20-100 parts by weight, respectively.

The polyfunctional carboxylic acid compound is selected from the group consisting of adipic acid, suberic acid, aberic acid, azelic acid, sebacic acid, dodecanedioic acid, trimeric acid, and mixtures thereof.

The polyfunctional alcohol compound is selected from the group consisting of diols, such as ethylene glycol, butane diol, or hexane diol; triols, such as trimethylol propane; and mixtures thereof. Polytetramethylene ether glycol (PTMG) has a hydroxyl value of 56.1-561.0 mgKOH/g.

The ether-containing polyester polyol having a hydroxyl value of 11.22-224.11 mgKOH/g is prepared by mixing the polyfunctional carboxylic acid compound, the polyfunctional alcohol compound, and polytetramethylene ether glycol to obtain a mixture, raising the temperature from room temperature to 140-160° C., then maintain the mixture at 150° C., which is first elevated temperature, for about 60˜120 min, further raising the temperature from 150° C. to 210-230° C., maintaining the mixture at 220° C., which is second elevated temperature for about 10-120 min, applying a vacuum of 650-760 mmHg at the second increased temperature, and when an acid value reaches 1 mgKOH/g, terminating the reaction.

Further, in the composition for the preparation of TPU of the present invention, isocyanate is selected from the group consisting of diphenyl methane diisocyanate (MDI), toluene diisocyanate (TDI), hexamethylene diisocyanate (HDI), dicyclohexylmethane diisocyanate (H₁₂MDI), isoporone diisocyanate (IPDI), and mixtures thereof.

As the isocyanate compound, any compound the same as or similar to those used for the common polyurethane preparation may be used.

Preferably, the isocyanate compound includes, for example, aromatic isocyanates, aliphatic isocyanates or alicyclic isocyanates, and more preferably, it is selected from the group consisting of diphenyl methane diisocyanate (MDI), toluene diisocyanate (TDI), hexamethylene diisocyanate (HDI), dicyclohexylmethane diisocyanate (H₁₂MDI), isoporone diisocyanate (IPDI), and mixtures thereof.

Further, in the composition for the preparation of TPU of the present invention, the chain-extension agent is selected from the group consisting of diols, such as ethylene glycol, diethylene glycol, butane diol, or hexane diol; triols, such as trimethylolpropane; polytetramethylene ether glycol; and mixtures thereof.

The TPU containing ether-containing polyester polyol according to the present invention is prepared by manufacturing a polymer resin through polyaddition of mixture of 15-60 parts by weight of an isocyanate compound, 30-70 parts by weight of ether-containing polyester polyol, and 5-40 parts by weight of a chain-extension agent, followed by blending and extruding 0.1-5 parts by weight of montan wax relative to 100 parts by weight of the polymer resin.

The method for preparing TPU containing montan wax serving as a slip agent, and prepared from ether-containing polyester polyol is the followings:

(a) mixing 30-70 parts by weight of ether-containing polyester polyol with 5-40 parts by weight of a chain-extension agent at 30-100° C. for 1-10 min with stirring;

(b) mixing the mixture obtained in (a) with 15-60 parts by weight of isocyanate at 300-1000 rpm for 1-10 min;

(c) aging the mixture obtained in (b) at 60-140° C. for 1-48 hours;

(d) pulverizing the aged product at a temperature 6° C. or below;

(e) blending the pulverized product with 0.1-5 parts by weight of montan wax relative to 100 parts by weight of the pulverized product; and

(f) extruding the blend at 150-300° C.

At step (a), the polyol compound is uniformly mixed with the chain-extension agent. The step (b) is the process of mixing the isocyanate compound with ether-containing polyester polyol to actually polymerize polyurethane.

The isocyanate compound and ether-containing polyester polyol are observed to quickly react as soon as they are mixed. In the present invention, the method is characterized by including the process of aging polyurethane as a reaction mixture obtained at step (b) to adjust the molecular weight of polyurethane as the resultant reaction product.

Subsequently, polyurethane as the reaction product undergoes known pulverization, blending with a slip agent, and extrusion, to have an appropriately adjusted size thereof. That is, the reaction product is processed through pulverization and extrusion processes, to form a pellet for use in manufacturing end products.

Further, the present invention provides the method of preparing TPU, wherein the montan wax comprises at least one selected from the group consisting of esters of montanic acids with ethylene glycol, esters of montanic acids with glycerine, calcium montanate containing montanic acid esters, and complex esters of montanic acids.

Further, the present invention provides the method of preparing TPU, wherein the montan wax is at least two montan wax comprising calcium montanate containing montanic acid esters.

Further, the present invention provides the method of preparing TPU, wherein the montan wax is calcium montanate containing montanic acid esters.

Further, the present invention provides the method of preparing TPU, wherein the ether-containing polyester polyol comprises a polyfunctional carboxylic acid compound, a polyfunctional alcohol compound, and polytetramethylene ether glycol, and have a hydroxyl value of 11.22-224.11 mgKOH/g.

Further, the present invention provides the method of preparing TPU, wherein the isocyanate is selected from the group consisting of diphenyl methane diisocyanate, toluene diisocyanate, hexamethylene diisocyanate, dicyclohexylmethane diisocyanate, isoporone diisocyanate, and mixtures thereof.

Further, the present invention provides the method of preparing TPU, wherein the chain-extension agent is selected from the group consisting of ethylene glycol, diethylene glycol, butane diol, hexane diol, trimethylolpropane, polytetramethylene ether glycol, and mixtures thereof.

In addition, the present invention provides a molded product, produced by subjecting TPU prepared using the above method to a powder slush molding process.

Examples and comparative examples will be stated below which are set forth to illustrate, but are not to be construed to limit the present invention.

### EXAMPLE

### 1. Example and Comparative Examples

### (1) Example 1

49.6 kg of adipic acid, 22.0 kg of 1,4-butylene glycol, and 40.7 kg of polytetramethylene ether glycol having a hydroxyl value of 448.8 mgKOH/g were mixed together, and the temperature was raised from room temperature to 150° C., after which the mixture was allowed to react at 150° C. as a first elevated temperature for about 90 min. Subsequently, the temperature was further raised from 150° C. to 220° C., and then the mixture was allowed to react at 220° C. as a second elevated temperature for about 30 min, followed by applying a vacuum of 720 mmHg at the second elevated temperature. When an acid value reached 1 mgKOH/g or below, the reaction was terminated, thereby preparing ether-containing polyester polyol having 12.29% condensed water and a hydroxyl value of 74.8 mgKOH/g.

Thereafter, 61 kg of ether-containing polyester polyol thus prepared and 6 kg of 1,4-butylene glycol were mixed with stirring at 60° C. for 3 min, and then 43 kg of hexamethylene diisocyanate were added, mixing with stirring at 500 rpm for 3 min to obtain a polymer, which was then aged at 80° C. for 8 hr. Subsequently, the aged polymer was pulverized at a temperature not higher than 0° C. to form flaky shape.

There, calcium montanate containing montanic acid ester was added in an amount of 4 parts by weight relative to 100 parts by weight of the flakes, after which the resultant mixture was extruded at 180° C. to form pellets with a pulverized shape. The pellet-shaped TPU was then subjected to a known powder slush molding process, to produce a molded product including core material, pad material and skin material, part of which was then sampled.

### (2) Comparative Example 1

Flakes were the same, but an external slip agent was not added.

### (3) Comparative Example 2

Flakes were the same, but an amount of calcium montanate containing montanic acid ester was 8 parts by weight of relative to 100 parts by weight of the flakes.

### (4) Comparative Example 3

Flakes were the same, but an external slip agent was modified polyethylene wax and an amount of the modified polyethylene wax was 4 parts by weight relative to 100 parts by weight of the flakes.

### (5) Comparative Example 4

Flakes were the same, but an external slip agent was stearic acid and an amount of the stearic acid was 4 parts by weight relative to 100 parts by weight of the flakes.

2. Comparison Tests of Processability of Powder Slush Molding and Properties of Molded Products

(1) Comparison Test of Processability of Powder Slush Molding

Each of the samples obtained in Example 1 and Comparative Examples 1-4 was subjected to a powder slush molding process. The powder slush molding process was conducted under the following conditions. After the test was repeated 5 times, an average value was determined.

i) Process Temperature: a mold temperature immediately before molding (a minimum process temperature required to avoid problems of the generation of non-molded portions and pinholes in the molded product)

ii) Cooling Time: a minimum time required to decrease the mold temperature to below 45° C. after molding (TPU is difficult to release at a mold temperature higher than 45° C. after cooling)

iii) Release Time: an average time required for release

iv) Cycle Time: a total time required to conduct a process steps of preheating, molding, cooling and releasing of molding material.

(2) Comparison Test of Properties of Molded Products

Test pieces for measuring individual properties are obtained from instrument panel (IP) for automobile interior material prepared through a powder slush molding process. The properties of the molded product were measured under the following conditions and standards.

After the test was repeated 5 times, an average value was determined.

i) Hardness: ASTM D 2240

ii) Tensile Strength and Elongation: ASTM D 412

iii) Tear Strength: ASTM D 624

iv) Melt Index (MI): ASTM D 1238 (165° C. 2.16 kg)

v) Blooming

120 days after the test pieces were allowed to stand at 30° C. and 70% relative humidity, the surface of the test pieces was observed with the naked eye. The results were given in Table 1 below.

TABLE 1

| | | Ex. 1 | Comp. Ex. 1 | Comp. Ex. 2 | Comp. Ex. 3 | Comp. Ex. 4 |
|---|---|---|---|---|---|---|
| Powder Slush | Process Temp. | 200 | 210 | 195 | 205 | 205 |
| Molding | (° C.) | | | | | |
| Process | Cooling Time | 20 | 35 | 20 | 25 | 25 |
| | (sec) | | | | | |
| | Release Time | 6 | 40 | 6 | 8 | 10 |
| | (sec) | | | | | |
| | Cycle Time | 540 | 589 | 540 | 547 | 549 |
| | (sec) | | | | | |
| | Note | Superior | Release | Superior | Good | Good |
| | | Release | Impossible | Release | Release | Release |
| Properties of | Hardness | 74 | 74 | 74 | 74 | 74 |
| Molded | (Shore A) | | | | | |
| Product | Tensile | 133 | 135 | 131 | 133 | 134 |
| | Strength | | | | | |
| | (Kgf/cm²) | | | | | |
| | Tear Strength | 70 | 72 | 71 | 70 | 72 |
| | (Kgf/cm) | | | | | |
| | Elongation | 850 | 850 | 850 | 850 | 850 |
| | (%) | | | | | |
| | MI (g/10 min) | 55 | 54 | 55 | 55 | 54 |
| | Blooming | No | No | Yes | Yes | Yes |

3. Comparison of Flatness of Molded Products

Flatness of molded products was measured under the following conditions.

Individual test pieces for comparison of individual flatness were obtained from IP skin for automobile interior material produced through a powder slush molding 15 process in Example 1 and Comparative Examples 1-4.

Whether pin holes were generated in the molded product was observed with the naked eye, and relative pin hole generation frequencies were determined, to assay the outer appearance of the IP skin.

The results are given in Table 2 below.

TABLE 2

| | | | C. | | |
|---|---|---|---|---|---|
| | Ex. 1 | C. Ex. 1 | Ex. 2 | C. Ex. 3 | C. Ex. 4 |
| Outer | No Pin | Generation | No | Generation | Generation |
| Appearance | Holes | of Pin | Pin | of Pin Holes | of Pin Holes |
| | | Holes | Holes | at Edge | at Edge |

From the test results, TPU of the present invention comprising ether-containing polyester polyol and montan wax was found to make release easy and to have an effect of reducing a process cycle time through reduction of molding energy due to a lowered process temperature, and an effect of improving the surface properties of molded end products.

There is an advantage in the present invention in that when a composition for the preparation of TPU for use in a powder slush molding process is used, a molded product is easily released at a powder slush molding process, and molding energy is lowered by lowing a process temperature, thereby shortening a process cycle time, and also, the decreased incidence of a blooming phenomenon and of pin holes results in improved flatness of the molded product.

What is claimed is:

1. A composition for preparation of a thermoplastic polyurethane elastomer for use in a powder slush molding process, the composition comprising:
a polymer, including 30-70 parts by weight of ether-containing polyester polyol, 15-60 parts by weight of isocyanate, and 5-40 parts by weight of a chain-extension agent; and
0.1-5 parts by weight of montan wax, serving as a slip agent, relative to 100 parts by weight of the polymer.

2. The composition as defined in claim 1, wherein said montan wax is at least one selected from the group consisting of esters of montanic acids with ethylene glycol, esters of montanic acids with glycerine, calcium montanate containing montanic acid esters, and complex esters of montanic acids.

3. The composition as defined in claim 2, wherein said montan wax is at least two montan wax which includes calcium montanate containing montanic acid esters.

4. The composition as defined in claim 2, wherein said montan wax is calcium montanate containing montanic acid esters.

5. The composition as defined in claim 1, wherein said ether-containing polyester polyol comprises a polyfunctional carboxylic acid compound, a polyfunctional alcohol compound, and polytetramethylene ether glycol, and has a hydroxyl value of 11.22-224.11 mgKOH/g.

6. The composition as defined in claim 1, wherein said isocyanate is selected from the group consisting of diphenyl methane diisocyanate (MDI), toluene diisocyanate (TDI), hexamethylene diisocyanate (HDI), dicyclohexylmethane diisocyanate (H₁₂MDI), isoporone diisocyanate (IPDI), and mixtures thereof.

7. The composition as defined in claim 1, wherein said chain-extension agent is selected from the group consisting of ethylene glycol, diethylene glycol, butane diol, hexane diol, trimethylolpropane, polytetramethylene ether glycol, and mixtures thereof.

8. A method of preparing a thermoplastic polyurethane elastomer for use in a powder slush molding process, comprising:
(a) mixing 30-70 parts by weight of ether-containing polyester polyol with 5-40 parts by weight of a chain-extension agent at 30-100° C. for 1˜10 min with stirring;
(b) mixing the mixture obtained in (a) with 15-60 parts by weight of isocyanate at 300-1000 rpm for 1-10 min;
(c) aging the mixture obtained in (b) at 60-140° C. for 1-48 hours;
(d) pulverizing the aged product at a temperature 0° C. or below;
(e) blending the pulverized product with 0.1-5 parts by weight of montan wax relative to 100 parts by weight of the pulverized product; and
(f) extruding the blended product obtained in (e) at 150-300° C.

9. The method as defined in claim 8, wherein said montan wax is at least one selected from the group consisting of esters of montanic acids with ethylene glycol, esters of montanic acids with glycerine, calcium montanate containing montanic acid esters, and complex esters of montanic acids.

10. The method as defined in claim 8, wherein said montan wax is at least two esters of montan wax which includes calcium montanate containing montanic acid esters.

11. The method as defined in claim 8, wherein said montan wax is calcium montanate containing montanic acid esters.

12. The method as defined in claim 8, wherein said ether-containing polyester polyol comprises a polyfunctional carboxylic acid compound, a polyfunctional alcohol compound, and polytetramethylene ether glycol, and has a hydroxyl value of 11.22-224.11 mgKOH/g.

13. The method as defined in claim 8, wherein said isocyanate is selected from the group consisting of diphenyl methane diisocyanate, toluene diisocyanate, hexamethylene diisocyanate, dicyclohexylmethane diisocyanate, isoporone diisocyanate, and mixtures thereof.

14. The method as defined in claim 8, wherein said chain-extension agent is selected from the group consisting of ethylene glycol, diethylene glycol, butane diol, hexane diol, trimethylolpropane, polytetramethylene ether glycol, and mixtures thereof.

15. A molded product, which is molded using the thermoplastic polyurethane elastomer prepared according to the method of claim 8 through a powder slush molding process.

16. A molded product, which is molded using the thermoplastic polyurethane elastomer prepared according to the method of claim 9 through a powder slush molding process.

17. A molded product, which is molded using the thermoplastic polyurethane elastomer prepared according to the method of claim 10 through a powder slush molding process.

18. A molded product, which is molded using the thermoplastic polyurethane elastomer prepared according to the method of claim 11 through a powder slush molding process.

19. A molded product, which is molded using the thermoplastic polyurethane elastomer prepared according to the method of claim 12 through a powder slush molding process.

20. A molded product, which is molded using the thermoplastic polyurethane elastomer prepared according to the method of claim 13 through a powder slush molding process.

21. A molded product, which is molded using the thermoplastic polyurethane elastomer prepared according to the method of claim 14 through a powder slush molding process.
